(19) United States
(12) Patent Application Publication
(10) Pub. No.: US 2019/0293600 A1
(43) Pub. Date: Sep. 26, 2019

(54) ELECTROPHORESIS SUPPORT, ELECTROPHORESIS DEVICE , AND METHOD FOR MANUFACTURING ELECTROPHORESIS SUPPORT

(71) Applicant: Panasonic Intellectual Property Management Co., Ltd., Osaka (JP)

(72) Inventor: MITSUOKI HISHIDA, Osaka (JP)

(21) Appl. No.: 16/318,144

(22) PCT Filed: Jul. 10, 2017
(86) PCT No.: PCT/JP2017/025092

§ 371 Date: Jan. 16, 2019

(30) Foreign Application Priority Data
Aug. 10, 2016 (JP) 2016-157160

(51) Int. Cl. G01N 27/453

(52) U.S. Cl. CPC G01N 27/453

(57) ABSTRACT

Provided are an electrophoresis support, an electrophoresis device, and a method for manufacturing the electrophoresis support in which an isoelectric point is stably adjustable with high reproducibility. The electrophoresis support according to the present disclosure is an electrophoresis support for use in electrophoresis of a sample, and includes a substrate having, in the substrate, a plurality of gaps through which a solution containing the sample flows, and fixed acceptor or donor ions with which surfaces of the substrate are doped. The surfaces face the gaps. This configuration enables the electrophoresis support having a highly reproducible isoelectric point to be provided stably.

### TECHNICAL FIELD

The present disclosure relates to an electrophoresis support and an electrophoresis device for use in analyzing protein or other samples, and a method for manufacturing the electrophoresis support.

### BACKGROUND ART

Electrophoresis is used as a method for separating and analyzing samples, such as deoxyribonucleic acid (DNA) and protein. Electrophoresis is a technique in which samples are separated by utilizing differences in molecular weight or isoelectric point of the samples. For example, isoelectric focusing separates samples by utilizing differences in isoelectric point of the samples.

An electrophoresis device includes electrodes, which apply an electric potential, and an electrophoresis support, which is provided between the electrodes. Conventionally, electrophoresis supports are formed of a nonwoven glass fabric or a polyacrylamide gel, for example.

As cited references related to an invention of the present disclosure, PTL 1 and PTL 2, for example, are known.

### CITATION LIST

### Patent Literature

PTL 1: Unexamined Japanese Patent Publication No. 2004-361393

PTL 2: Unexamined Japanese Patent Publication No. 2005-84047

### SUMMARY OF THE INVENTION

### Technical Problem

An electrophoresis support used in electrophoresis has a predetermined isoelectric point. Several methods are known for adjusting the isoelectric point of the electrophoresis support. With such conventional methods, however, it has been difficult to adjust the isoelectric point of the electrophoresis support with high reproducibility.

The present disclosure addresses the above issue, and an object of the present disclosure is to provide an electrophoresis support whose isoelectric point is stably adjustable with high reproducibility.

### Solution to Problem

An electrophoresis support according to the present disclosure is an electrophoresis support for use in electrophoresis of a sample. The electrophoresis support includes a substrate having, in the substrate, a plurality of gaps through which a solution containing the sample flows, and fixed ions with which surfaces of the substrate are doped. The surfaces face the gaps. The fixed ions including at least one of an acceptor ion and a donor ion.

An electrophoresis device according to the present disclosure is an electrophoresis device that performs electrophoresis of a sample. The electrophoresis device includes a container, a pair of first electrodes provided in the container, and a first electrophoresis support disposed between the pair of first electrodes. The first electrophoresis support includes a substrate having, in the substrate, a plurality of gaps through which a solution containing the sample flows, and fixed ions with which surfaces of the substrate are doped. The surfaces face the gaps. The fixed ions including at least one of an acceptor ion and a donor ion.

A method for manufacturing an electrophoresis support according to the present disclosure is a method for manufacturing an electrophoresis support for use in electrophoresis of a sample. The method includes doping surfaces of a substrate with fixed ions, the substrate having, in the substrate, a plurality of gaps through which a solution containing the sample flows. The surfaces face the gaps. The fixed ions including at least one of an acceptor ion and a donor ion.

### Advantageous Effect of Invention

In an electrophoresis support, an electrophoresis device, and a method for manufacturing the electrophoresis support according to the present disclosure, an isoelectric point of the electrophoresis support is stably adjustable with high reproducibility.

### BRIEF DESCRIPTION OF DRAWINGS

FIG. 1 is a schematic top view of an electrophoresis device according to a first exemplary embodiment.

FIG. 2 is a schematic cross-sectional view of the electrophoresis device according to the first exemplary embodiment.

FIG. 3 is a schematic cross-sectional view of an electrophoresis support according to the first exemplary embodiment.

FIG. 4 is a schematic cross-sectional view of another example of the electrophoresis support according to the first exemplary embodiment.

FIG. 5 is a schematic cross-sectional view of still another example of the electrophoresis support according to the first exemplary embodiment.

FIG. 6 is an enlarged schematic view of a part of the electrophoresis support illustrated in FIG. 5.

FIG. 7 is a schematic top view of an electrophoresis device according to a first modified example of the first exemplary embodiment.

FIG. 8 is a schematic top view of another example of an electrophoresis support according to the first modified example.

FIG. 9 is a schematic top view of an electrophoresis device according to a second exemplary embodiment.

FIG. 10 is a schematic cross-sectional view of the electrophoresis device according to the second exemplary embodiment.

FIG. 11 is a conceptual view schematically illustrating a detected image of an electrophoresis support according to the second exemplary embodiment.

### DESCRIPTION OF EMBODIMENTS

Prior to describing exemplary embodiments of the present disclosure, issues associated with an electrophoresis device using a conventional electrophoresis support are discussed below.

Electrophoresis is a phenomenon in which charged particles of samples move when voltage is applied to a pair of electrodes placed in an analysis solution containing the samples. The samples travel through gaps of an electrophoresis support. At this time, the samples travel through the gaps at different speeds according to molecular weights of the respective samples. Thus, the samples are separated by differences in the distance the samples travel during the voltage application time. Also, the samples each travel through gaps to a respective position where the sample has the same electric potential as the electrophoresis support, according to the amount of electric charge of the sample. Thus, the samples are separated by differences in isoelectric point.

In electrophoresis, controlling the isoelectric point of the electrophoresis support is important. The isoelectric point of the electrophoresis support depends on, for example, the hydrogen ion exponent (pH) of material of the electrophoresis support. The pH of the electrophoresis support affects movement of samples. For example, in electrophoresis of protein, the pH of the electrophoresis support affects the protein's moving speed, for example. Thus, to achieve accurate electrophoresis, the pH of the electrophoresis support needs to be controlled with high reproducibility.

In isoelectric focusing, an electrophoresis support having a pH gradient is used. One method to form a pH gradient in an electrophoresis support is to add a substrate ampholite and apply voltage during electrophoresis. In the conventional electrophoresis support, however, the pH gradient of the electrophoresis support is unstable and has low reproducibility. Another method to form a pH gradient in an electrophoresis support is to place acid or basic acrylamide derivatives in a polyacrylamide gel and form a pH gradient in the gel in advance. In this method, however, preparation of the gel is complicated, and productivity is low.

In addition, the electrophoresis support using a gel needs to maintain a certain amount of moisture to keep the gel state and a porous structure of the gel. Thus, a package for keeping moisture needs to be used to store the electrophoresis support using a gel. Also, the electrophoresis support using a gel is difficult to downsize from the viewpoint of drying.

An electrophoresis support, an electrophoresis device, and a method for manufacturing the electrophoresis support according to exemplary embodiments of the present disclosure are described below in detail with reference to the drawings. The exemplary embodiments described below each illustrate one specific preferable example of the present disclosure. Thus, numerical values, shapes, materials, constituent elements, arrangement positions and connection modes of the constituent elements, and the like illustrated in the following exemplary embodiments are merely examples, and therefore are not intended to limit the present disclosure. Accordingly, of the constituent elements in the following exemplary embodiments, constituent elements not recited in the independent claim indicating the broadest concept of the present invention are described as optional constituent elements.

Furthermore, the drawings are schematic views and do not necessarily provide precise illustration. In the drawings, the same reference numerals are assigned to substantially the same structures, and duplicate description is omitted or simplified.

### First Exemplary Embodiment

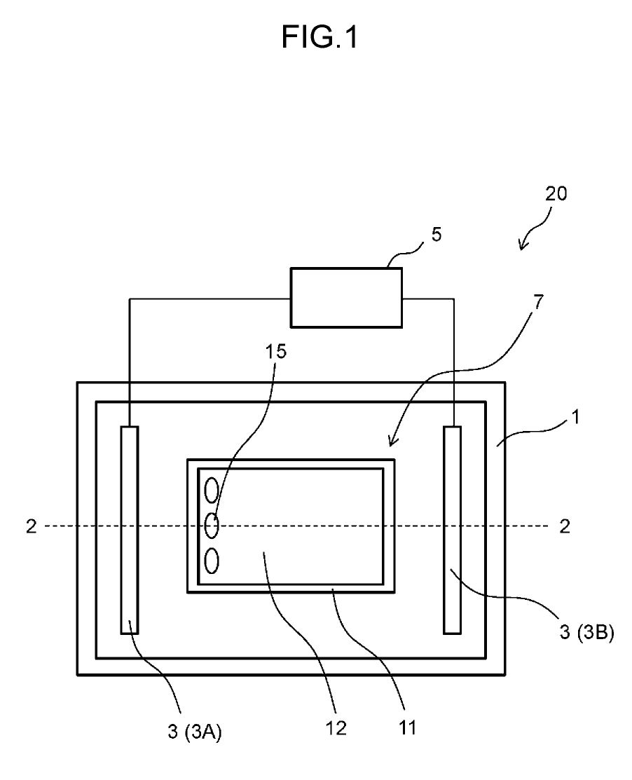

An electrophoresis device and an electrophoresis support according to an aspect of the present disclosure are described with reference to FIGS. 1 to 3.

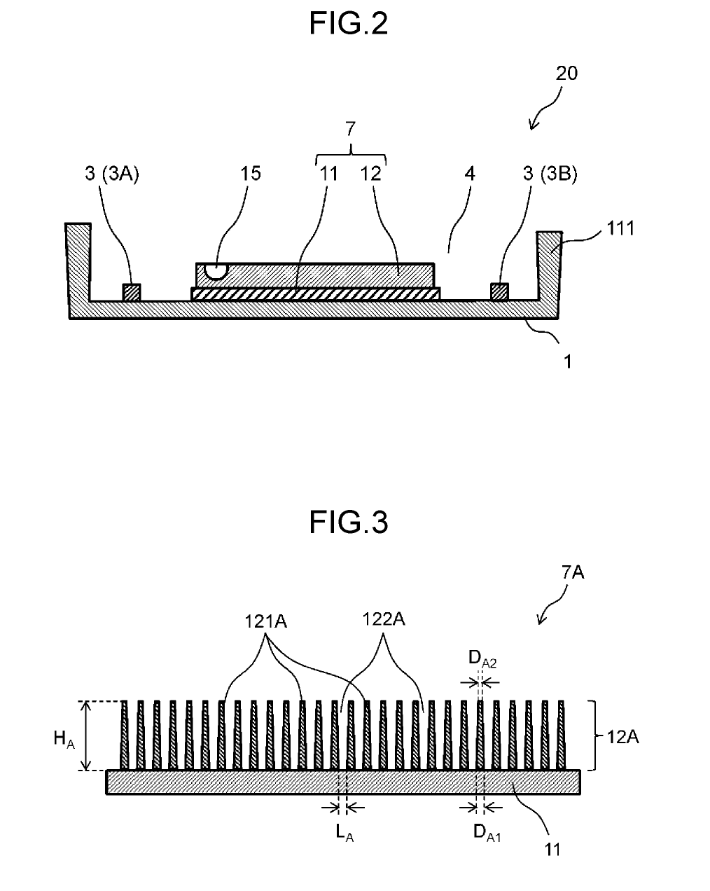

FIG. 1 is a top view of electrophoresis device 20. FIG. 2 is a cross-sectional view taken along line 2-2 in FIG. 1 illustrating electrophoresis device 20.

Electrophoresis device 20 includes container 1, electrophoresis support 7, and electrodes 3.

Electrophoresis device 20 separates samples contained in a solution by utilizing differences in isoelectric point or molecular weight. The samples are biological samples, for example, protein and DNA.

Container 1 has chamber 4 in an upper surface of container 1. Chamber 4 is filled with a buffer solution or other liquid when electrophoresis is performed. For this reason, side walls 111 of container 1 forming chamber 4 are provided to keep the liquid from spilling. Material of container 1 is resin, such as polymer resin, silicon, or metal, for example. Container 1 is formed by injection molding or by machining, for example, depending on the material of container 1. Container 1 is preferably made of material that does not affect electrophoresis. In chamber 4 of container 1, electrophoresis support 7 and electrodes 3 are provided.

When a small quantity of solution is used, samples and the buffer solution or other liquid can be retained on the upper surface of container 1 by surface tension. Container 1 thus does not necessarily have chamber 4.

Electrophoresis support 7 includes base substrate 11 and substrate 12 provided on base substrate 11. Substrate 12 has injection portion 15 at an end of substrate 12. Samples are injected into injection portion 15. Substrate 12 has a plurality of internal gaps. In electrophoresis, injected samples travel through the gaps in substrate 12. Material of substrate 12 is a metal oxide, for example.

Electrophoresis support 7 is manufactured by doping substrate 12 provided on base substrate 11 with ions.

Substrate 12 having the internal gaps contains the introduced dopant ions. The ions are exposed at surfaces of substrate 12. The ions are fixed ions serving as acceptors or donors. That is, substrate 12 has the dopant fixed acceptor or donor ions in the surfaces of substrate 12 that face the internal gaps of substrate 12.

Substrate 12 has a predetermined isoelectric point, which is dependent on the dopant ions. Hence, the isoelectric point of substrate 12 is easily adjustable by adjusting the implant dose or type of the dopant ions.

The term “surfaces” includes surfaces and areas near the surfaces. The areas near the surfaces are regions that extend from the substrate surfaces to a depth of 5 μm, for example.

The dopant ions that are introduced into substrate 12 are, for example, oxygen ions (O²⁻), hydrogen ions (H⁺), chlorine ions (Cl⁻), calcium ions (Ca²⁺), or sodium ions (Na⁺). The dopant ions may be ions of a single element alone. Alternatively, the dopant ions may be ions of multiple elements in combination. The combination of ions of multiple elements may be a combination of donor ions and acceptor ions.

The ions are implanted into substrate 12 by ion implantation. The ions are implanted at a dose ranging from 5×10¹⁰ atoms cm⁻² to 1×10¹⁵ atoms cm⁻², for example. Also, the ions are implanted at an acceleration voltage of 10 keV, for example. The ion implant dose and the ion acceleration voltage are values that are determined as appropriate according to the material, thickness, and other feature of substrate 12.

After the ion implantation, substrate 12 is subjected to a rapid thermal annealing (RTA) process. The RTA process is performed at a temperature ranging from 900° C. to 1100° C. for 30 seconds, for example. The RTA process activates the dopant ions introduced into substrate 12. The activation of the dopant ions causes substrate 12 to have an electric charge corresponding to the type and dose of the implanted ions. Therefore, the isoelectric point of substrate 12 of electrophoresis support 7 is stably controllable.

The impurity implantation and the RTA process are capable of repairing defects within the metal oxide material, thereby achieving the effect of stabilizing device characteristics. The method for placing the fixed acceptor or donor ions into the surfaces of substrate 12 is not limited to ion implantation. Another method, for example, solid state diffusion of impurities, may be used to fix the fixed ions in the surfaces of substrate 12.

Substrate 12 of electrophoresis support 7 is specifically described below.

FIG. 3 is a schematic cross-sectional view of electrophoresis support 7A, which is an example of electrophoresis support 7.

Electrophoresis support 7A includes base substrate 11 and substrate 12A provided on base substrate 11.

Substrate 12A is an aggregate of nanowires 121A. Nanowires 121A are projections having a crystalline structure, for example. Nanowires 121A are formed substantially perpendicular to base substrate 11. Nanowires 121A are provided on base substrate 11 at predetermined distances L_{A}. Gaps 122A of substrate 12A are spaces between nanowires 121A. Samples travel through gaps 122A.

Nanowires 121A may be inclined at a predetermined angle with respect to base substrate 11.

Nanowires 121A are formed by liquid phase epitaxy or vapor phase epitaxy, for example. Specifically, nanowires 121A may be formed using a vapor liquid solid (VLS) method, for example.

In the VLS method, desired metal material and oxygen gas are supplied in the presence of a metal catalyst at a temperature ranging from about 200° C. to about 1300° C. to develop crystal growth immediately below the metal catalyst. With this method, single-crystal nanowires 121A are formed.

Nanowires 121A have height H_{A} ranging from 1.0 μm to 50 μm (inclusive), for example. Nanowires 121A have diameter D_{A} ranging from 0.1 μm to 1.0 μm (inclusive), for example. Diameter D of nanowires 121A is an average thickness of nanowires 121A. Distances L_{A} between nanowires 121A, that is, gaps 122A, have a size ranging from 0.1 μm to 10 μm (inclusive), for example.

Nanowires 121A are formed to extend from base substrate 11. Diameter D_{A1} of an end of each nanowire 121A close to base substrate 11 is greater than diameter D_{A2} of the other end of each nanowire 121A.

Height H_{A} and diameter D, for example, of nanowires 121A are controllable by controlling conditions, such as temperature and pressure, in the manufacturing process. Also, the size of gaps 122A is easily adjustable by controlling diameter D or density of nanowires 121A.

Nanowires 121A are formed of a metal oxide, for example.

Examples of the metal oxide include SnO₂, ZnO, In₂O₃, Fe₃O₄, NiO, CuO, TiO₂, and SiO₂. The metal oxide has an isoelectric point dependent on the material of the metal oxide, in a liquid.

For example, nanowires 121A made of SiO₂ have an isoelectric point of around pH 2. Nanowires 121A made of ZnO have an isoelectric point ranging from about pH 9 to about pH 10. When substrate 12A is formed of nanowires 121A made of a single metal oxide alone, substrate 12A has an isoelectric point equal to the isoelectric point of the metal oxide. Nanowires 121A may also be made of a plurality of metal oxides. Nanowires 121A forming substrate 12A may be formed of a plurality of metal oxides having different isoelectric points. Forming substrate 12A of a mixture of nanowires 121A having different isoelectric points allows fine adjustment of the isoelectric point of substrate 12A.

Introduced dopant ions are provided in surfaces of nanowires 121A facing the gaps. Doping with the dopant ions results in nanowires 121A having an isoelectric point corresponding to the implant dose and type of the ions. This enables substrate 12A of electrophoresis support 7A to be controlled to have a predetermined isoelectric point.

The isoelectric point of nanowires 121A may vary depending on the material of nanowires 121A and the method for forming nanowires 121A, for example. In such cases, doping nanowires 121A with the ions reduces variation in the isoelectric point of nanowires 121A.

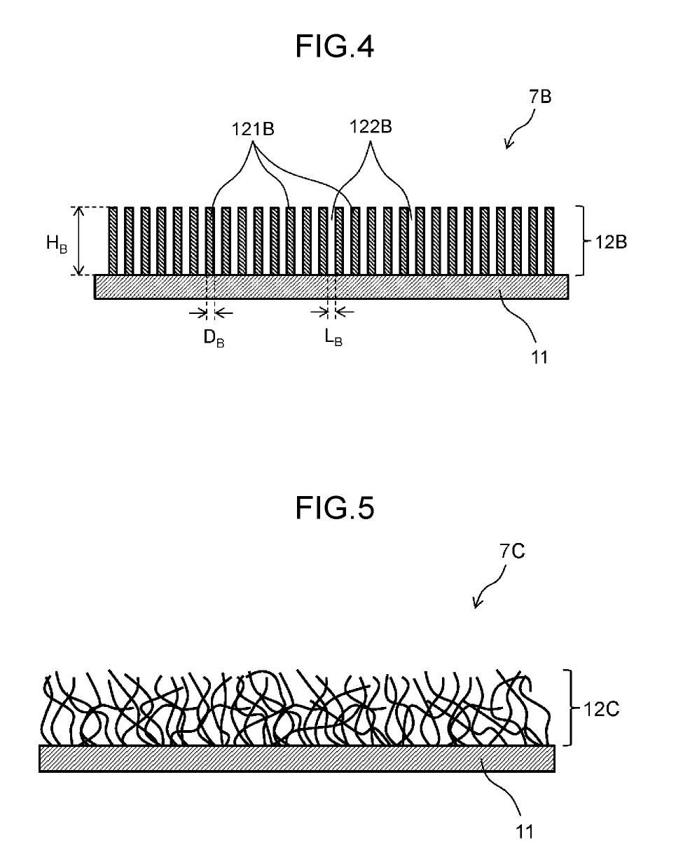

FIG. 4 is a schematic cross-sectional view of electrophoresis support 7B, which is another example of electrophoresis support 7.

Electrophoresis support 7B includes base substrate 11 and substrate 12B provided on base substrate 11.

Substrate 12B is an aggregate of pillar-shaped structures 121B. Pillar-shaped structures 121B are rectangular prismatic, for example. Pillar-shaped structures 121B are formed substantially perpendicular to base substrate 11.

Pillar-shaped structures 121B are provided on base substrate 11 at predetermined distances L_{B}. Gaps 122B of substrate 12B are spaces between pillar-shaped structures 121B. Samples travel through gaps 122B.

Pillar-shaped structures 121B may be inclined at a predetermined angle with respect to base substrate 11.

Pillar-shaped structures 121B are formed by processing a substrate by utilizing micro electro mechanical systems (MEMS) fabrication technology, for example. Specifically, pillar-shaped structures 121B can be formed by using a deep reactive ion etching (DRIE) process, for example. The use of the DRIE process reduces variation in diameter D_{B} of pillar-shaped structures 121B. This enables the formation of pillar-shaped structures 121B with high accuracy.

The substrate is semiconductor material, for example, silicon. Also, the substrate may be an oxide semiconductor. Examples of the oxide semiconductor include SnO₂, ZnO, In₂O₃, Fe₃O₄, Fe₂O₃, Fe₂TiO₃, NiO, CuO, Cu₂O, TiO₂, SiO₂, In₂O₃, and WO₃. When pillar-shaped structures 121B are formed by etching, base substrate 11 and pillar-shaped structures 121B are formed of the same material as the substrate.

Pillar-shaped structures 121B have an isoelectric point dependent on the material of pillar-shaped structures 121B, in a liquid.

Pillar-shaped structures 121B have height Hs ranging from 10 μm to 200 μm, for example. Pillar-shaped structures 121B have diameter D_{B} of 20 μm, for example. Distances L_{B} between pillar-shaped structures 121B, that is, gaps 122B, have a size ranging from 1 μm to 40 μm (inclusive), for example. The size of pillar-shaped structures 121B, however, is not limited to these values.

A diameter of an end of each pillar-shaped structure 121B close to base substrate 11 is preferably equal to a diameter of the other end of each pillar-shaped structure 121B. This allows the size of gaps 122B of substrate 12B to have a fixed value.

Height H_{B} and diameter D_{B}, for example, of pillar-shaped structures 121B are controllable by varying conditions in the manufacturing process. The size of gaps 122B is easily adjustable by controlling diameter D_{B} or density of pillar-shaped structures 121B.

Introduced dopant ions are provided in surfaces of pillar-shaped structures 121B facing the gaps. Doping with the dopant ions results in pillar-shaped structures 121B having an isoelectric point corresponding to the implant dose and type of the ions. This enables substrate 12B of electrophoresis support 7B to be controlled to have a predetermined isoelectric point.

The isoelectric point of pillar-shaped structures 121B may vary depending on the material of pillar-shaped structures 121B and the method for forming pillar-shaped structures 121B, for example. In such cases, doping pillar-shaped structures 121B with the ions reduces variation in the isoelectric point of pillar-shaped structures 121B.

FIG. 5 is a schematic cross-sectional view of electrophoresis support 7C, which is another example of electrophoresis support 7.

Electrophoresis support 7C includes base substrate 11 and substrate 12C provided on base substrate 11.

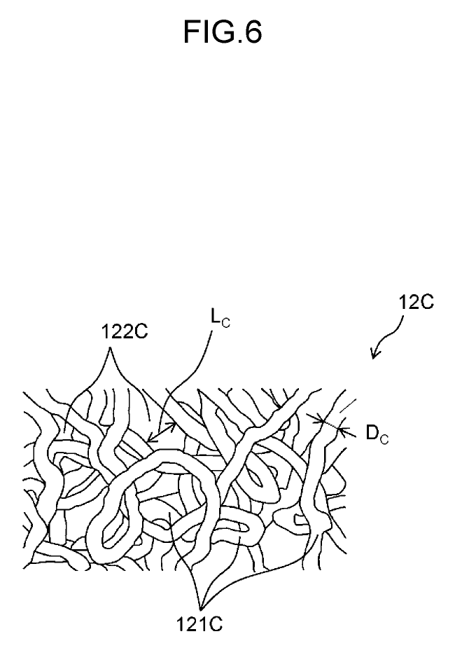

FIG. 6 is an enlarged cross-sectional view of a part of substrate 12C.

Substrate 12C is an aggregate of fibers 121C. Fibers 121C have an amorphous structure. Fibers 121C having an amorphous structure are flexible. Fibers 121C are irregularly entangled with one another. Gaps 122C of substrate 12C are spaces between fibers 121C. Gaps 122C do not have a fixed size, but are of a size randomly varying within a predetermined range. Samples travel through gaps 122C.

Fibers 121C may be winding and divided into branches. Such a shape causes fibers 121C to be entangled more complicatedly.

Also, contact parts of entangled fibers 121C may be joined together. The fibers can be joined by using, for example, bonding with resin or other adhesive, or thermal welding of the fibers themselves.

Fibers 121C are formed by using a vaporized substrate deposition (VSD) process, for example. Fibers 121C are formed by controlling temperature, pressure, and other conditions in the manufacturing process.

Fibers 121C are formed of a metal oxide, for example.

Examples of the metal oxide include SnO₂, ZnO, In₂O₃, Fe₃O₄, NiO, CuO, TiO₂, and SiO₂. The metal oxide has an isoelectric point dependent on the material of the metal oxide, in a liquid.

Fibers 121C have diameter D_{c} ranging from 0.1 μm to 1.0 μm (inclusive), for example. Diameter D_{c} of fibers 121C is an average thickness of nanowires 121A. Distances L_{c} between fibers 121C, that is, gaps 122A, have a size ranging from 0.1 μm to 10 μm (inclusive), for example.

Introduced dopant ions are provided in surfaces of fibers 121C facing the gaps. Doping with the dopant ions results in fibers 121C having an isoelectric point corresponding to the implant dose and type of the ions. This enables substrate 12C of electrophoresis support 7C to be controlled to have a predetermined isoelectric point.

The isoelectric point of fibers 121C may vary depending on the material of fibers 121C and the method for forming fibers 121C, for example. In such cases, doping fibers 121C with the ions reduces variation in the isoelectric point of fibers 121C.

Alternatively, fibers 121C may extend to be straight in shape.

The methods for manufacturing nanowires 121A, pillar-shaped structures 121B, and fibers 121C are not limited to the methods described above. Nanowires 121A, pillar-shaped structures 121B, and fibers 121C may be formed by using other suitable methods.

In electrophoresis support 7 illustrated in FIG. 2, base substrate 11 may be a bottom surface of chamber 4 of container 1. Further, when the shape of electrophoresis support 7 can be held by substrate 12 alone, base substrate 11 does not need to be provided.

Electrodes 3 are provided at both ends of electrophoresis support 7. To be specific, anode 3A is provided near one end of electrophoresis support 7. Cathode 3B is provided near the other end of electrophoresis support 7. As material of electrodes 3, for example, conductive material, such as gold, platinum, copper, carbon, or a complex of these elements, is used. Electrodes 3 are separated by a distance ranging from 10 mm to 50 mm, for example. Electrodes 3 are connected with power source 5 illustrated in FIG. 1.

Power source 5 controls voltage applied between anode 3A and cathode 3B and voltage application time.

The following describes how electrophoresis device 20 operates.

A buffer solution is injected into container 1 in which electrophoresis support 7 is disposed. As the buffer solution, phosphate buffered saline (PBS), for example, is used. Samples are then injected into injection portion 15 of electrophoresis support 7. Subsequently, power source 5 applies a predetermined voltage between electrodes 3. For example, a voltage of 50 V is applied between electrodes 3 for ten minutes. The voltage value is then raised to 300 V over an hour and a half. Then, a voltage of 300 V is applied between electrodes 3 for three hours and a half. The voltage application forms an electric field between electrodes 3. The electric field causes the samples to travel through electrophoresis support 7. At this time, the samples travel different distances at different speeds according to differences in molecular weight and isoelectric point of the samples. As a result, the samples are separated in electrophoresis support 7 after the electrophoresis. Electrophoresis device 20 may be subjected to a stationary treatment before the samples are injected.

After the samples are separated, electrophoresis support 7 is dyed to detect positions of the separated samples. Electrophoresis support 7 is dyed by silver staining, for example. Alternatively, the samples may be dyed with a fluorescent dye before the electrophoresis is performed. In this case, electrophoresis support 7 is irradiated with excitation light after the electrophoresis to observe the fluorescence, thereby detecting the positions of the separated samples.

Alternatively, for the detection of the samples, another method may be used in which electrophoresis support 7 is irradiated with ultraviolet light, near-infrared light, or other light, and transmitted light or reflected light of the irradiation light is detected. Samples, such as protein and DNA, have the property of absorbing light having a specific wavelength. Hence, when the irradiation light that has been applied to electrophoresis support 7 is detected, the detected light has lower intensity in the areas where the samples are located than in the other areas. This enables detection of the positions of the samples.

### First Modified Example

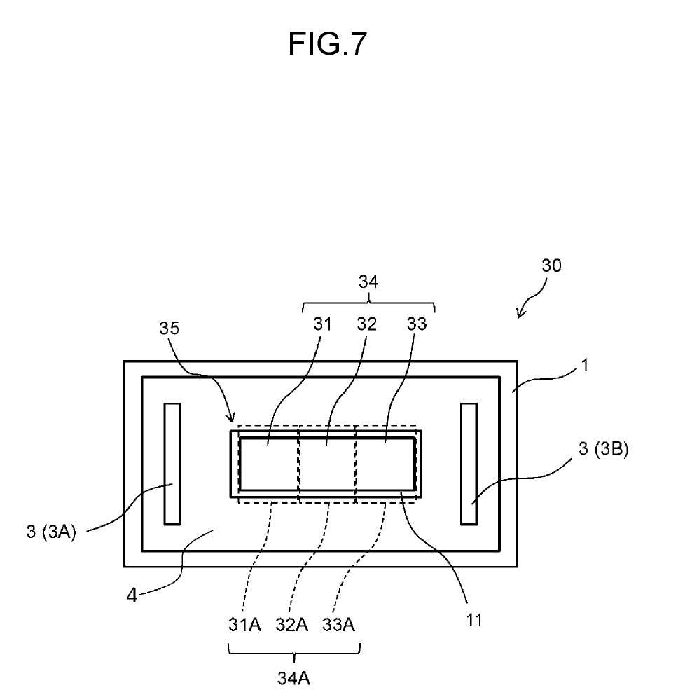

With reference to FIG. 7, electrophoresis device 30 according to the present modified example of the first exemplary embodiment is described.

FIG. 7 is a top view of electrophoresis device 30 according to the present modified example.

Electrophoresis device 30 disclosed in the present modified example has a plurality of regions having different isoelectric points in substrate 34 of electrophoresis support 35. In the following description, differences from the first exemplary embodiment are mainly described. Common matters are denoted by the same reference numerals, and are not described in detail.

Electrophoresis device 30 includes container 1 having chamber 4, electrophoresis support 35 disposed in chamber 4, and electrodes 3.

Electrophoresis support 35 has first region 31A, second region 32A, and third region 33A. Apart of substrate 34 located in first region 31A is first substrate 31. A part of substrate 34 located in second region 32A is second substrate 32. A part of substrate 34 located in third region 33A is third substrate 33.

First substrate 31, second substrate 32, and third substrate 33 each have internal gaps. First region 31A, second region 32A, and third region 33A have different isoelectric points.

First substrate 31 is doped with first ions. To be specific, the first ions are provided in surfaces of first substrate 31. Second substrate 32 is doped with second ions. To be specific, the second ions are provided in surfaces of second substrate 32. Third substrate 33 is doped with third ions. To be specific, the third ions are provided in surfaces of third substrate 33.

The first ions, the second ions, and the third ions may be the same ions or different ions.

First substrate 31, second substrate 32, and third substrate 33 may be made of the same material or different materials. Substrate 34 may include first substrate 31, second substrate 32, and third substrate 33 that have been formed separately and joined together. Alternatively, substrate 34 may include first substrate 31, second substrate 32, and third substrate 33 that have been formed integrally in one piece.

For example, when first substrate 31, second substrate 32, and third substrate 33 are made of the same material, either or both of the type and dose of dopant ions are adjusted for each substrate, thereby enabling first region 31A, second region 32A, and third region 33A to have different isoelectric points.

For single substrate 34 made of the same material, one method to change the ion implant dose for each of first region 31A, second region 32A, and third region 33A is to perform ion implantation with a metal mask placed on a surface of substrate 34. An opening size of the metal mask is controlled according to the ion implant dose for each of first region 31A, second region 32A, and third region 33A. Use of the metal mask with the varying opening size in the ion implantation allows the ion implant dose to be changed for each of first region 31A, second region 32A, and third region 33A in single substrate 34. This enables the manufacture of electrophoresis support 35 in which first region 31A, second region 32A, and third region 33A have different isoelectric points.

The isoelectric point of first substrate 31 is lower than the isoelectric point of second substrate 32. Further, the isoelectric point of second substrate 32 is lower than the isoelectric point of third substrate 33. In this manner, first substrate 31, second substrate 32, and third substrate 33 are disposed in electrophoresis support 35 in ascending order of the isoelectric points in a direction from anode 3A to cathode 3B.

Specifically, in electrophoresis support 35, for example, first substrate 31 having an isoelectric point of pH 2, second substrate 32 having an isoelectric point of pH 7, and third substrate 33 having an isoelectric point of pH 9 are arranged in this order. In this way, electrophoresis support 35 has a pH gradient.

Electrophoresis support 35 may additionally include a plurality of regions 34A. Adding regions 34A having different isoelectric points allows finer adjustment of the pH gradient of electrophoresis support 35. For example, substrate 34 may be disposed to have a pH gradient from pH 2 to pH 12 in increments of pH 1. In regions 34A, respective parts of substrate 34 are doped with ions to have predetermined isoelectric points.

The electrophoresis support having the pH gradient can be used for isoelectric focusing, for example.

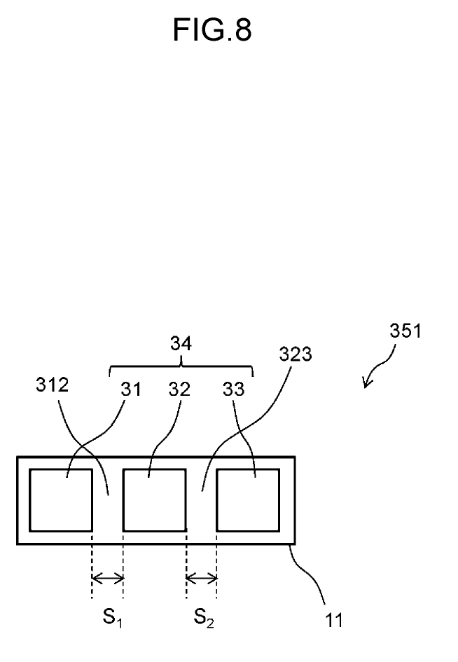

FIG. 8 is a schematic top view of another example of electrophoresis support 35 according to the present modified example.

In electrophoresis support 351, first substrate 31 and second substrate 32 are disposed on base substrate 11 with space 312 of predetermined distance S₁. Second substrate 32 and third substrate 33 are disposed on base substrate 11 with space 323 of predetermined distance S2. Distance S₁ is equal to distance S₂. Predetermined distances S₁, S₂ are less than gap sizes of first substrate 31, second substrate 32, and third substrate 33.

Each side of first substrate 31, second substrate 32, and third substrate 33 is 2.5 mm, for example. In this case, distance S₁ and distance S₂ are 1 mm, for example.

A sample having an isoelectric point between the isoelectric point of the first substrate and the isoelectric point of the second substrate travels to the space between first substrate 31 and second substrate 32 and stops. Similarly, a sample having an isoelectric point between the isoelectric point of the second substrate and the isoelectric point of the third substrate travels to the space between second substrate 32 and third substrate 33 and stops.

In this way, electrophoresis support 351, which uses space 312 between first substrate 31 and second substrate 32 and space 323 between second substrate 32 and third substrate 33, is capable of more precise electrophoresis.

As described above, in electrophoresis supports 7, 35, the isoelectric points are stably adjustable with high reproducibility. Moreover, electrophoresis supports 7, 35 use no gel. This eliminates the need to use a package for keeping moisture, for example, in storing electrophoresis supports 7, 35. Electrophoresis supports 7, 35 are also easy to downsize.

Furthermore, electrophoresis supports 7, 35 with the stable isoelectric points are achieved at low cost by implanting ions into electrophoresis support 7.

### Second Exemplary Embodiment

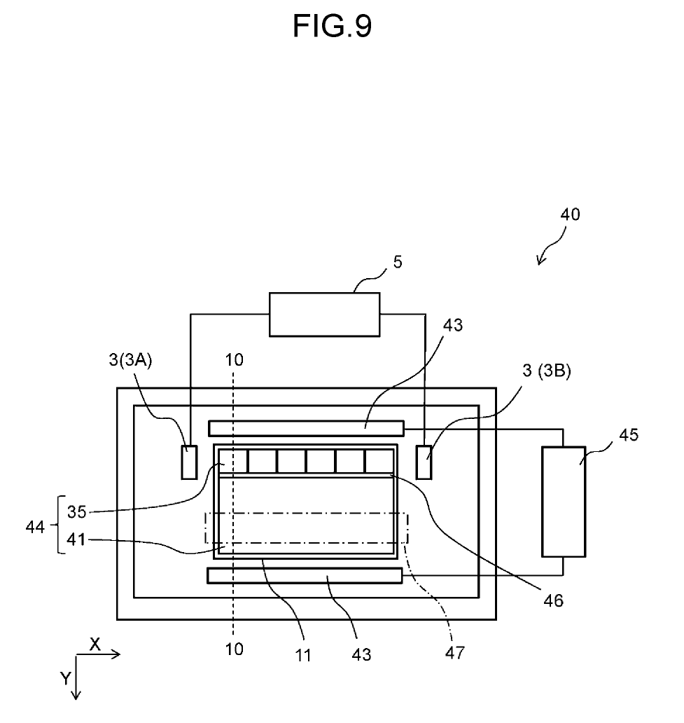

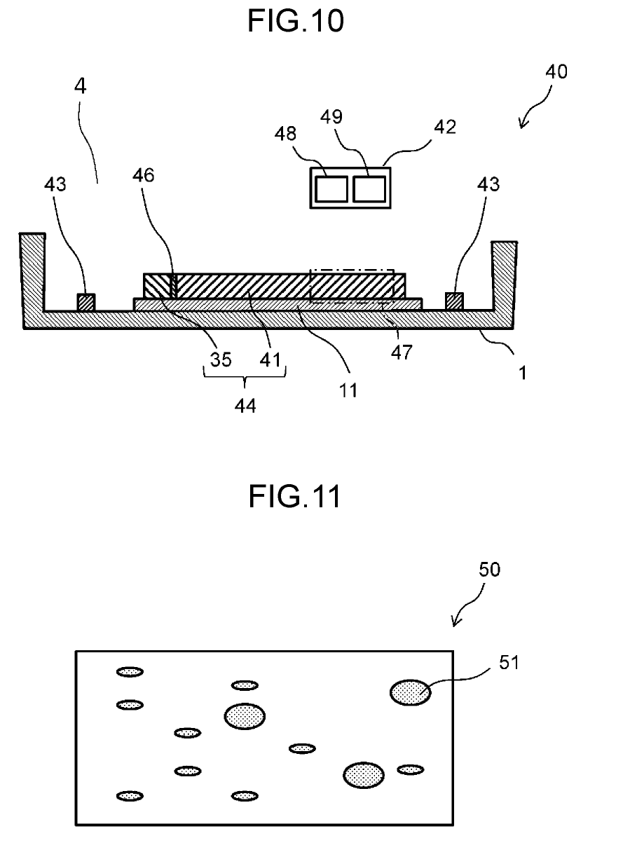

With reference to FIGS. 9 and 10, electrophoresis device 40 according to the present exemplary embodiment is described.

FIG. 9 is a top view of electrophoresis device 40 according to the present exemplary embodiment. FIG. 10 is a cross-sectional view taken along line 10-10 in FIG. 9 illustrating electrophoresis device 40.

Electrophoresis device 40 according to the present exemplary embodiment is used for two-dimensional electrophoresis. Electrophoresis device 30 and electrophoresis support 35 disclosed in the first modified example of the first exemplary embodiment can be used in isoelectric focusing in a first dimension of the two-dimensional electrophoresis. In the following description, differences from the first exemplary embodiment are mainly described. Common matters are denoted by the same reference numerals, and are not described in detail.

Electrophoresis device 40 includes container 1 having chamber 4, electrophoresis support 44, electrodes 3, 43, power sources 5, 45, and detector 42. Electrophoresis support 44 includes first-dimension electrophoresis support 35 and second-dimension electrophoresis support 41.

Electrophoresis in the first dimension is isoelectric focusing. As first-dimension electrophoresis support 35, electrophoresis support 35 according to the first modified example is used. In FIG. 9, first-dimension electrophoresis support 35 has a pH gradient formed of six regions having different isoelectric points.

Also, second-dimension electrophoresis support 41 is integrally joined to a side surface of first-dimension electrophoresis support 35. A direction (Y-direction) of electrophoresis in a second dimension is orthogonal to a direction (X-direction) of the electrophoresis in the first dimension.

Electrophoresis support 41 is joined to the side surface of electrophoresis support 35 with partition 46 interposed between electrophoresis support 41 and electrophoresis support 35. In this way, electrophoresis support 35 and electrophoresis support 41 are disposed to be in indirect contact with each other. Electrophoresis support 35 and electrophoresis support 41 may be disposed in container 1 to be in direct contact with each other.

In the electrophoresis in the second dimension, samples are separated by utilizing differences in molecular weight of the samples. Second-dimension electrophoresis support 41 is electrophoresis support 7 including substrate 12 disclosed in the first exemplary embodiment, or an electrophoresis support including a gel. When electrophoresis support 7 including substrate 12 is used, electrophoresis support 41 is preferably formed of single substrate 12. The electrophoresis support including a gel is formed of an agarose gel or a polyacrylamide gel, for example.

The following describes operation in the two-dimensional electrophoresis.

First-dimension electrophoresis support 35 holds a buffer solution. As the buffer solution, PBS, for example, is used. The buffer solution is in contact with electrodes 3. In this situation, preferably, there is no leakage of the buffer solution toward second-dimension electrophoresis support 41. Electrophoresis support 35 may be filled with the buffer solution in advance or before electrophoresis is performed.

Next, samples are placed in an injection portion of first-dimension electrophoresis support 35. Subsequently, power source 5 applies a predetermined voltage between electrodes 3. For example, a voltage of 50 V is applied between electrodes 3 for one minute. The voltage value is then raised to 300 V over an hour and a half. Subsequently, a voltage of 300 V is applied between electrodes 3 for three hours and a half. The voltage application forms an electric field between electrodes 3. When the electric field is formed, the samples each travel through electrophoresis support 35 until the sample reaches a respective isoelectric point at which an electric charge of the sample becomes zero. Consequently, the samples are separated in electrophoresis support 35 after the electrophoresis according to the respective isoelectric points of the samples. Electrophoresis device 40 may be subjected to a stationary treatment before the samples are placed.

Subsequently, the samples that have been separated according to the isoelectric points in the electrophoresis in the first dimension are subjected to electrophoresis in the second dimension. Power supply 45 applies a predetermined voltage between electrodes 43. For example, a voltage of 300 V is applied between electrodes 43 for three hours. The voltage application causes the samples to travel through second-dimension electrophoresis support 41 in the Y direction. In the electrophoresis in the second dimension, the samples are separated according to differences in molecular weight of the samples.

Second-dimension electrophoresis support 41 holds a buffer solution different from the buffer solution held by first-dimension electrophoresis support 35. The buffer solution held by second-dimension electrophoresis support 41 is PBS that contains sodium dodecyl sulfate (SDS). Partition 46 is provided between first-dimension electrophoresis support 35 and second-dimension electrophoresis support 41. Partition 46 separates electrophoresis support 35 from electrophoresis support 41. Partition 46 is removed after the electrophoresis in the first dimension is complete. The partition prevents leakage of the buffer solution held by second-dimension electrophoresis support 41 toward electrophoresis support 35 during the electrophoresis in the first dimension. Therefore, electrophoresis device 40 is capable of performing the electrophoresis in the first dimension with high accuracy.

After the samples are separated by the electrophoresis in the second dimension, electrophoresis support 41 is dyed. This allows detection of the positions of the separated samples. Electrophoresis support 41 is dyed by silver staining, for example. Alternatively, the samples may be dyed with a fluorescent dye before the electrophoresis is performed. In this case, electrophoresis support 41 is irradiated with excitation light after the electrophoresis to observe the fluorescence, thereby detecting the positions of the samples.

Alternatively, for the detection of the samples, another method may be used in which electrophoresis support 41 is irradiated with ultraviolet light, near-infrared light, or other light, and transmitted light or reflected light of the irradiation light is detected. Samples, such as protein and DNA, have the property of absorbing light having a specific wavelength. Hence, when the irradiation light that has been applied to electrophoresis support 41 is detected, the detected light has lower intensity in the areas where the samples are located than in the other areas. This enables detection of the positions of the samples.

FIG. 11 is detected image 50 of second-dimension electrophoresis support 41 that has been dyed after the separation of the samples.

In detected image 50, detected positions 51 are in six columns in the X-direction. This indicates that the samples have been separated into six isoelectric points by the electrophoresis in the first dimension. Also, in each column, detected positions 51 are distributed in the Y-axis direction. This indicates that the samples that have been separated according to the isoelectric points by the electrophoresis in the first dimension are separated according to differences in molecular weight of the samples in the electrophoresis in the second dimension.

As described above, the samples are separated according the isoelectric points and molecular weights of the respective samples. The detected samples can be identified by using a molecular weight marker, for example. Also, in a case where a result of two-dimensional electrophoresis for a specific sample exists as a reference image in advance, detected image 50 may be compared with the reference image for the identification of the analyzed samples.

One method to obtain detected image 50 may be to detect the samples during the electrophoresis in the second dimension. For example, as illustrated in FIGS. 9 and 10, detector 42 is provided above detection region 47 of second-dimension electrophoresis support 41. Detector 42 includes irradiator 48, which applies ultraviolet light or other light, and photo-sensing device 49, which receives light. Detection region 47 of detector 42 is a part of a lengthwise (the Y-axis direction) region and an entire widthwise (the X-axis direction) region of second-dimension electrophoresis support 41. Detector 42 is secured to, for example, electrophoresis device 40 to prevent changes in a relative positional relationship with second-dimension electrophoresis support 41.

Detector 42 detects the samples in electrophoresis support 41 during the electrophoresis by reconstructing an electrophoresis pattern using light applied to detection region 47.

Electrophoresis support 41 reflects the light applied by irradiator 48. The reflected light is received by photo-sensing device 49. Detector 42 obtains intensity of the received light as time series data. When a sample is in electrophoresis support 41, the sample absorbs the applied light. This reduces the intensity of the reflected light received.

The obtained data is plotted on a graph to create detected image 50 as illustrated in FIG. 11. In the graph, a vertical axis indicates time. A horizontal axis indicates widthwise position in detection region 47. A size of respective detected positions 51 indicates information on intensity of light. The size of detected positions 51 is, for example, a reciprocal of intensity of light.

When the detection is performed by using transmitted light of the light applied to detection region 47, irradiator 48 and photo-sensing device 49 are provided at positions symmetrical with respect to detection region 47.

In this way, detected image 50 of the separated samples is obtained during the electrophoresis, thereby shorting the sample detection time. The information on the received light is not limited to the intensity of the light. For example, the information on the light may be a frequency of the light, for example.

Substrate 12 described above may have a structure in which, for example, surfaces of a framework formed of resin, metal, or other material are coated with a metal oxide.

Although dopant ions are used to control the isoelectric point of substrate 12, the isoelectric point of substrate 12 can be controlled by properties of material of substrate 12 without using dopant ions.

The electrophoresis supports, the electrophoresis devices, and the methods for manufacturing the electrophoresis supports according to one or more aspects have been described above based on the exemplary embodiments. The present disclosure, however, is not limited to these exemplary embodiments. Various modifications to the exemplary embodiments that are conceivable by those skilled in the art, and forms configured by combining constituent elements employed in the different exemplary embodiments may be included in the scope of the one or more aspects without departing from the spirit of the present disclosure.

### INDUSTRIAL APPLICABILITY

Electrophoresis supports, electrophoresis devices, and methods for manufacturing the electrophoresis supports according to the present disclosure are useful for separating samples, such as protein and DNA.

### REFERENCE MARKS IN THE DRAWINGS

1 container
111 side wall
3, 43 electrode
3A anode
3B cathode
4 chamber
5, 45 power source
7, 7A, 7B, 7C, 35, 351, 41, 44 electrophoresis support
11 base substrate
12, 12A, 12B, 12C substrate
121A nanowire
122A, 122B, 122C gap
121B pillar-shaped structure
121C fiber
15 injection portion
20, 30, 40 electrophoresis device
31 first substrate
31A first region
32 second substrate
32A second region
33 third substrate
33A third region
34 substrate
34A region
312, 323 space
42 detector
46 partition
47 detection region
48 irradiator
49 photo-sensing device
50 detected image
51 detected position

1. An electrophoresis support for use in electrophoresis of a sample, the electrophoresis support comprising:
a substrate having a plurality of gaps through which a solution containing the sample flows; and
fixed ions with which surfaces of the substrate are doped, the surfaces facing the gaps, the fixed ions including at least one of an acceptor ion and a donor ion.

2. The electrophoresis support according to claim 1, wherein
the substrate is an aggregate of a plurality of nanowires,
the gaps are provided between the plurality of nanowires, and
the fixed ions are provided in surfaces of the nanowires, the surfaces facing the gaps.

3. The electrophoresis support according to claim 1, wherein
the substrate is an aggregate of a plurality of pillar-shaped structures,
the gaps are provided between the plurality of pillar-shaped structures, and
the fixed ions are provided in surfaces of the pillar-shaped structures, the surfaces facing the gaps.

4. The electrophoresis support according to claim 1, wherein
the substrate is a fibrous structure formed of a plurality of entangled fibers, and
the fixed ions are provided in surfaces of the plurality of fibers forming the fibrous structure, the surfaces facing the gaps.

5. The electrophoresis support according to claim 1, wherein the substrate comprises a metal oxide.

6. The electrophoresis support according to claim 1, wherein
the substrate includes a first substrate and a second substrate having respective different isoelectric points, and
an amount of the fixed ions with which the first substrate is doped is different from an amount of the fixed ions with which the second substrate is doped.

7. The electrophoresis support according to claim 1, wherein
the substrate includes a first substrate and a second substrate having respective different isoelectric points,
the first substrate has first fixed ions with which surfaces of the first substrate are doped,
the second substrate has second fixed ions with which surfaces of the second substrate are doped, and
the first fixed ions are of a different type than the second fixed ions.

8. The electrophoresis support according to claim 1, wherein
the substrate includes a first substrate, a second substrate, and a third substrate,
an isoelectric point of the first substrate is lower than an isoelectric point of the second substrate,
the isoelectric point of the second substrate is lower than an isoelectric point of the third substrate, and
the first substrate, the second substrate, and the third substrate are arranged in this order.

9. The electrophoresis support according to claim 8, wherein a space of a predetermined distance is provided between the first substrate and the second substrate, and a space of a predetermined distance is provided between the second substrate and the third substrate.

10. An electrophoresis device that performs electrophoresis of a sample, the electrophoresis device comprising:
a container;
a pair of first electrodes provided in the container; and
a first electrophoresis support disposed between the pair of first electrodes,
wherein the first electrophoresis support includes:
a substrate having a plurality of gaps through which a solution containing the sample flows; and
fixed ions with which surfaces of the substrate are doped, the surfaces facing the gaps, the fixed ions including at least one of an acceptor ion and a donor ion.

11. The electrophoresis device according to claim 10, wherein the substrate comprises a metal oxide.

12. The electrophoresis device according to claim 10, wherein
the substrate includes a plurality of regions having respective different isoelectric points resulting from the doping of the fixed ions, and
the plurality of regions are provided in ascending order of the isoelectric points from an end of the first electrophoresis support toward the other end of the first electrophoresis support.

13. The electrophoresis device according to claim 12, wherein the substrate has a space of a predetermined distance between any adjacent regions of the plurality of regions.

14. The electrophoresis device according to claim 10, further comprising:
a pair of second electrodes provided in the container; and
a second electrophoresis support disposed between the pair of second electrodes,
wherein the second electrophoresis support is integrally joined to a side surface of the first electrophoresis support.

15. The electrophoresis device according to claim 14, further comprising a partition provided between the second electrophoresis support and the first electrophoresis support.

16. The electrophoresis device according to claim 14, further comprising a detector configured to receive light applied to a detection region of the second electrophoresis support,
wherein the detector detects a sample moving through the second electrophoresis support by reconstructing an electrophoresis pattern by use of the light.

17. A method for manufacturing an electrophoresis support for use in electrophoresis of a sample, the method comprising doping surfaces of a substrate with fixed ions, the substrate having a plurality of gaps through which a solution containing the sample flows, the surfaces facing the gaps, the fixed ions including at least one of an acceptor ion and a donor ion.

18. The method according to claim 17, wherein the substrate comprises a metal oxide.

19. The method according to claim 18, wherein the substrate that has been doped with the fixed ions is further subjected to a rapid thermal annealing process.

20. The method according to claim 18, wherein
the substrate includes a first region and a second region, and
the first region and the second region of the substrate are each doped with a different amount of the fixed ions or a different type of the fixed ions to cause an isoelectric point of the first region and an isoelectric point of the second region to be different from each other.
